(19) United States
(12) Patent Application Publication
(10) Pub. No.: US 2007/0221050 A1
(43) Pub. Date: Sep. 27, 2007

(54) KEYBOARD

(75) Inventor: Feng-Ting Hsu, Taipei County (TW)

Correspondence Address: J C PATENTS, INC., 4 VENTURE, SUITE 250, IRVINE, CA, 92618, US

(73) Assignee: JENSIN INTL TECHNOLOGY CORP., Taipei County (TW)

(21) Appl. No.: 11/684,218

(22) Filed: Mar. 9, 2007

(30) Foreign Application Priority Data
Mar. 10, 2006 (TW) 95108073

(51) Int. Cl. G10H 1/32; G10H 3/00

(52) U.S. Cl. 84/744

(57) ABSTRACT

A keyboard for outputting a serial number to an identifiable chip of a model is provided. The model is shaped to correspond to one of the character roles, pets, stage artifacts, pieces or equipment in an online game. The keyboard includes a plurality of buttons and a signal-emitting module. The signal-emitting module is electrically connected to the buttons. The buttons are suitable for being pressed to make the signal-emitting module generate a serial number signal, and then the serial number signal is input to the identifiable chip through the signal-emitting module.

### CROSS-REFERENCE TO RELATED APPLICATION

This application claims the priority benefit of Taiwan application serial no. 95108073, filed Mar. 10, 2006. All disclosure of the Taiwan application is incorporated herein by reference.

### BACKGROUND OF THE INVENTION

1. Field of the Invention

The present invention relates to a keyboard, and more particularly, to a keyboard for inputting a serial number signal into an identifiable chip.

2. Description of Related Art

With the popularization of computer and the rapid progress in network communication, computer games have evolved from the former single machine version into a mode of operation that permits a number of people in different locations to battle with one another online simultaneously.

For example, popular computer network game providers allow a number of people to go on line and play games together through a server. The game companies provide the story lines of these online games and the game players are free to choose the particular character roles they want to play or create their own character roles. Then, by battling with monsters in the game, completing a specified mission according to the directions, or trading with other game players or shopping around, precious items including other character roles, pets, artifacts or equipment are obtained. These precious items are able to enhance the attack or defense capability of the character roles in the game. Thus, the players need to spend considerable time and effort battling with the monsters or accomplishing the mission just to obtain a few pieces or precious items.

However, most of the games are designed in such a way that pieces or other precious items will drop from the body of the monster in the vicinity of the role player when the monster is hit. Therefore, in the process of attacking the monster, other online game players may easily steal these dropped-out pieces or precious items without actually fighting the monster themselves. This often leads to questions about the fairness of the game.

Moreover, when the player wishes to retrieve the stolen pieces or precious items through the game company, there is no proof that the pieces or the precious items are stolen. Therefore, the game company cannot return these pieces or precious items to the original owner and these pieces or precious items are forever lost to the player. As a result, the problem of precious items being stolen is a concern to players and needs to be addressed.

### SUMMARY OF THE INVENTION

Accordingly, at least one objective of the present invention is to provide a keyboard for inputting a serial number to an identifiable chip of a model and resolving the problem of having precious items stolen in an online game.

To achieve these and other advantages and in accordance with the purpose of the invention, as embodied and broadly described herein, the invention provides a keyboard suitable for outputting a serial number to an identifiable chip of a model. The model is shaped into one of the character roles, pets, stage artifacts, pieces or equipment of the online game. The keyboard includes a plurality of buttons and a signal-emitting module. The buttons are suitable for being pressed to make the signal-emitting module generate a serial number signal, and then the serial number signal is input to the identifiable chip through the signal-emitting module.

In one embodiment of the present invention, the foregoing signal-emitting module includes a control circuit and a signal-emitting chip. The control circuit is located beneath keyboard. Furthermore, the buttons are suitable for being pressed to make the control circuit generate a serial number signal. The signal-emitting chip is electrically connected to the control circuit.

In one embodiment of the present invention, the foregoing buttons include letter keys and number keys.

In one embodiment of the present invention, the foregoing buttons include function keys.

In one embodiment of the present invention, the foregoing signal-emitting chip includes a radio frequency identification (RFID) chip, a Bluetooth chip or a wireless network chip.

In one embodiment of the present invention, the foregoing identifiable chip includes a radio frequency chip, a Bluetooth chip or a wireless network chip.

In one embodiment of the present invention, the foregoing signal-emitting module input the serial number signal to the identifiable chip through wireless transmission.

In one embodiment of the present invention, the foregoing signal-emitting module input the serial number signal to the identifiable chip through a transmission cable.

In the present invention, the keyboard inputs the serial number signal into the identifiable chip of the model so that the model having the identifiable chip will have a serial number identical to the character roles, pets, stage artifacts, pieces or equipment in the online game.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective diagram of a keyboard and a model according to the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

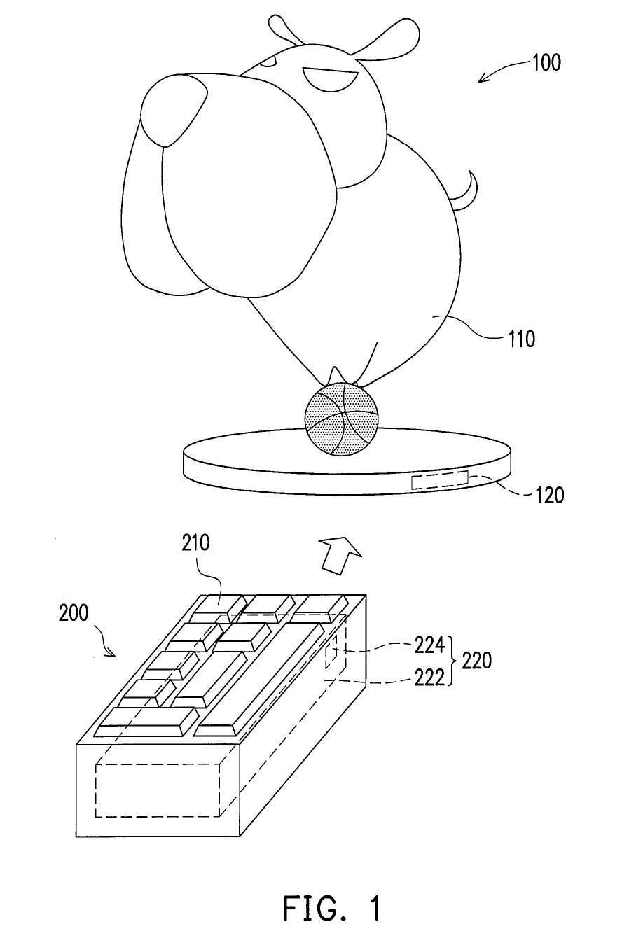

FIG. 1 is a perspective diagram of a keyboard and a model according to the present invention. As shown in FIG. 1, the keyboard 200 in the present invention is designed to correspond with an online game. Aside from allowing a user to input a serial number to a game server through a network connection so that the user can obtain precious items in the game, the keyboard 200 also outputs a serial number signal to an identifiable chip 120 of a model 100. Hence, the model 100 can have serial number identical to the precious items. In the present embodiment, the serial number can be pure letters or pure numbers or a combination of letters and numbers. In addition, the body 110 of the foregoing model 100 is fabricated with a shape resembling the character roles, pets, stage artifacts, pieces or equipment in the online game. Moreover, the identifiable chip 120 installed inside the body 110 of the model 100 can be a radio frequency identification chip, a Bluetooth chip, a wireless network chip or any chip capable of receiving a serial number signal.

The keyboard 200 includes a plurality of buttons 210 and a signal-emitting module 220. The signal-emitting module 220 is electrically connected to the buttons 210. The buttons 210 are suitable for being pressed to make the signal-emitting module 220 generate a serial number signal. The signal-emitting module 220 then inputs the serial number signal to the identifiable chip 120. In the present embodiment, the buttons 210 can be combination of letter keys and number keys. Obviously, the buttons 210 may also include some function keys.

More specifically, the signal-emitting module 220 in the present embodiment includes a control circuit 222 and a signal-emitting chip 224. The control circuit 222 is disposed underneath the buttons 210. When the buttons 210 are pressed, the control circuit 222 will generate a serial number signal. The signal-emitting chip 224 is electrically connected to the control circuit 222. The signal-emitting chip 224 is suitable for outputting the serial number signal to the identifiable chip 120 of the model 100. In the present embodiment, the signal-emitting chip 224 includes a radio frequency identification chip, a Bluetooth chip or a wireless network chip.

Referring to FIG. 1, when a user presses the keyboard to input a serial number, the keyboard 200 will transmit the user input serial number through the network to a game server so that the user can receive precious items of the game. As the user presses the keyboard 200, the control circuit 222 also generates a serial number signal. The serial number signal is transmitted away from the keyboard 200 via the signal-emitting chip 224 to be received by the identifiable chip 120 of the model 100. Therefore, the model 100 has a serial number that may serve as a means of personal identification. It should be noted that the signal-emitting module 220 in the present embodiment inputs the serial number signal to the identifiable chip 120 by means of a wireless transmission. However, in other embodiments (not shown), the signal-emitting module 220 may also input the serial number signal to the identifiable chip 120 by means of a cable transmission.

In summary, the keyboard in the present invention has a signal-emitting module. Therefore, by pressing the buttons on the keyboard, a user is able to make the control circuit of the signal-emitting module generate a serial number signal. The serial number signal is input to the identifiable chip of the model via the signal-emitting chip inside the signal-emitting module so that the model has a serial number for personal identification. Therefore, when some of the precious items in the online game are stolen from a player, the player may use the model, which has a serial number identical to the precious items, as a proof of ownership of the precious items and ask the game company to return the items. Thus, the problem of precious items being stolen from a player in an online game is resolved once and for all.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A keyboard suitable for outputting a serial number signal to an identifiable chip of a model, wherein the model is fabricated into a shape resembling one of character roles, pets, stage artifacts, pieces or equipment of an online game, comprising:
a plurality of buttons; and
a signal-emitting module electrically connected to the buttons, wherein the buttons are suitable for being pressed to make the signal-emitting module generate the serial number signal, and the signal-emitting module inputs the serial number signal to the identifiable chip.

2. The keyboard of claim 1, wherein the signal-emitting module comprises a control circuit and a signal-emitting chip electrically connected to the control circuit such that the control circuit located underneath the buttons will generate the serial number signal when the buttons being pressed.

3. The keyboard of claim 1, wherein the buttons comprise letter keys as well as number keys.

4. The keyboard of claim 3, wherein the keyboard further comprises function keys.

5. The keyboard of claim 1, wherein the signal-emitting chip comprises a radio frequency identification chip, a Bluetooth chip or a wireless network chip.

6. The keyboard of claim 5, wherein the identifiable chip comprises a radio frequency identification chip, a Bluetooth chip or a wireless network chip.

7. The keyboard of claim 6, wherein the signal-emitting module inputs the serial number signal to the identifiable chip through wireless transmission.

8. The keyboard of claim 1, wherein the signal-emitting module inputs the serial number signal to the identifiable chip through cable transmission.
